(19) United States
(12) Patent Application Publication
(10) Pub. No.: US 2010/0007229 A1
(43) Pub. Date: Jan. 14, 2010

(54) Vibration Motor

(76) Inventors: Do Hyun Kim, Ansan-si (KR); Young Il Park, Gunpo-si (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/169,356

(22) Filed: Jul. 8, 2008

(51) Int. Cl. H02K 7/065

(52) U.S. Cl. 310/81

(57) ABSTRACT

A vibration motor is provided. The vibration motor includes a case, a shaft, a rotor, a printed circuit board (PCB), and a coil. The case includes a lower case and an upper case. The case includes an insulating coating layer on the lower case thereof. The shaft is supported by the upper case and lower case. The rotor is rotatably coupled to the shaft to generate a vibration. The PCB is fixed to the lower case. The coil passes through the PCB and fixed to the lower case. the coil interacts with the rotor.

### BACKGROUND

The present disclosure relates to a vibration motor.

A vibration motor includes a lower case and an upper case that are coupled together. A lower end portion and an upper end portion of a shaft are supported to the lower case and the upper case, respectively. An eccentric rotor generating a vibration is rotatably installed at the shaft. A printed circuit board (PCB) is installed on the lower case. A coil is installed on the PCB. The coil interacts with the rotor to rotate the rotor.

With slim profile trends of electronic devices, a slimmer vibration motor is required.

### BRIEF SUMMARY

Embodiments provide a slimmer vibration motor.

In one embodiment, A vibration motor comprises: a case including a lower case and an upper case, the lower case formed with an insulating coating layer thereon; a shaft supported by the upper case and lower case; a rotor rotatably coupled to the shaft to generate a vibration; a printed circuit board fixed to the lower case; and a coil passing through the printed circuit board and fixed to the lower case, the coil interacting with the rotor to rotate the rotor.

The details of one or more embodiments are set forth in the accompanying drawings and the description below. Other features will be apparent from the description and drawings, and from the claims.

### BRIEF DESCRIPTION OF THE DRAWINGS

FIG. 1 is a cross-sectional view of a flat type vibration motor according to an embodiment.

FIG. 2 is a perspective view illustrating a lower case and components installed thereon of FIG. 1.

### DETAILED DESCRIPTION

Hereinafter, a vibration motor according to embodiments will be described in detail with reference to the accompanying drawings.

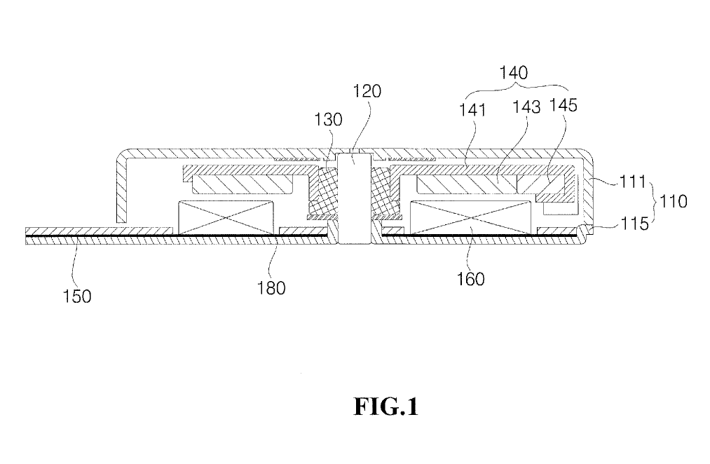

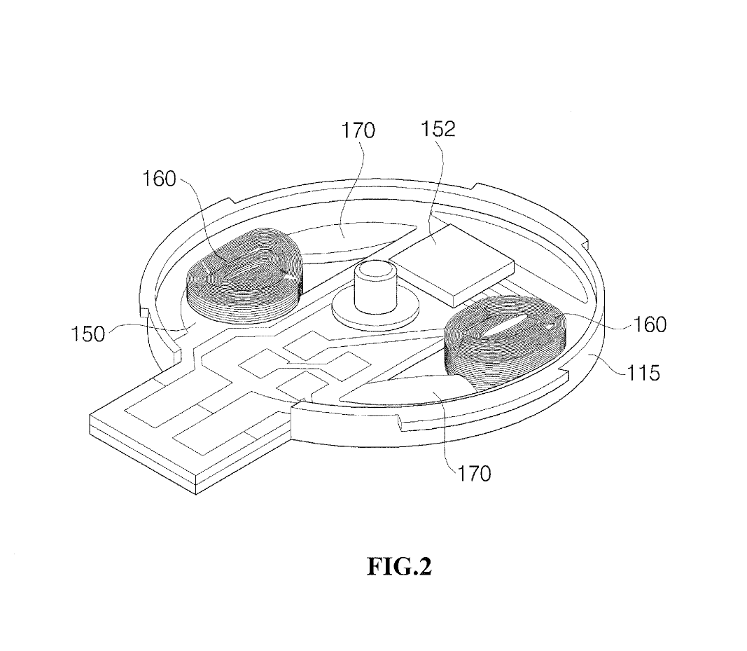

FIG. 1 is a cross-sectional view of a vibration motor according to an embodiment, and FIG. 2 is a perspective view illustrating a lower case and components installed thereon of FIG. 1.

Referring to FIGS. 1 and 2, a case 110 including an upper case 111 and a lower case 115 is prepared. The upper case 11 and the lower case 115 are coupled together to provide a predetermined space therein. The upper case 111 includes an upper plate and a side plate. The lower case 115 includes a side plate and a lower plate. A lower end portion of the side plate of the upper case 111 is coupled to an upper end portion of the side plate of the lower case 115. The upper plate of the upper case 111 and the lower plate of the lower case 115 are defined as an upper plate and a lower plate of the case 110, respectively.

An upper end portion and a lower end portion of a shaft 120 are supported by the upper case 111 and the lower case 115, respectively. A bearing 130 is rotatably fitted onto an outer peripheral surface of the shaft 120.

An eccentric rotor 140 including a magnet 143 and a weight 145 to generate a vibration is fixed to the bearing 130. A rotor yoke 141 is fixed to an outer peripheral surface of the bearing 130, and the magnet 143 is fixed to a bottom surface of the rotor yoke 141 to generate a magnetic field. The weight 145 is fixed to the bottom surface of the rotor yoke 141 to allow the rotor 149 to generate a large vibration.

A printed circuit board (PCB) 150 is fixed to the lower case 115. An integrated circuit (IC) 152 and a hall element (not shown) are mounted on the PCB 150. A coil 160 electrically connected to the PCB 150 is fixed to the lower case 115. For a slim profile of a vibration motor, the coil 160 passes through the PCB 150 and is fixed to an upper surface of the lower case 115.

When an external power is supplied to the coil 160 through the PCB 150, the rotor 140 rotates by an electromagnetic force generated between the coil 160 and the magnet 143 to generate the vibration.

A cogging plate 170 is provided on the lower case 115. The cogging plate 170 prevents the rotor 140 from being stopped at a point at which a toque becomes zero due to the electromagnetic force generated between the coil 160 and the magnet 143 to stably drive the motor. The cogging plate 170 may be fixed to an upper surface of the PCB 150.

Since the coil 160 passes through the PCB 150 and is fixed to the lower case 115, it is required that the coil 160 is insulated from the case 110.

In the vibration motor according to this embodiment, the lower case 115 is coated with parylene treated by plasma treatment. The surface of the parylene coating layer 180 is roughened by plasma treatment. Then, adhesive material(not shown) is coated on the surface of the parylene coating layer 180. because the parylene coating layer 180 has a roughened surface, the adhesive material can stick firmly to the parylene coating layer 180.

Therefore, the coil 160 is firmly adhered to the parylene coating layer 180 with the adhesive material. In the present invention the coil 160 and the case 110 can be easily insulated in a simple manner as well as without causing damage to surrounding components.

As described above, in the vibration motor according to the present disclosure, the upper surface of the lower plate of the case is coated with the parylene, and the coil is adhered to the parylene coating layer to insulate the coil from the lower plate of the case.

It will be apparent to those skilled in the art that various modifications and variations can be made in the present invention. Thus, it is intended that the present invention covers the modifications and variations of this invention provided they come within the scope of the appended claims and their equivalents.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A vibration motor comprising:
a case including a lower case and an upper case, the lower case formed with an insulating coating layer thereon;
a shaft supported by the upper case and lower case;
a rotor rotatably coupled to the shaft to generate a vibration;
a printed circuit board fixed to the lower case; and
a coil passing through the printed circuit board and fixed to the lower case, the coil interacting with the rotor to rotate the rotor.

2. The vibration motor according to claim 1, wherein the insulating coating layer is formed of parylene.

3. The vibration motor according to claim 2, wherein the parylene is treated by plasma treatment.

4. The vibration motor according to claim 1, wherein the coil is placed on the insulating coating layer.
